(19) United States
(12) Patent Application Publication
(10) Pub. No.: US 2007/0122569 A1
(43) Pub. Date: May 31, 2007

(54) Integration of conductive structures for plastic parts produced by a hot-press method (SMC/BMC)

(75) Inventors: Ingmar Petersen, Esslingen (DE); Bernd Schwarz, Waldorfhaslach (DE); Markus Pfletschinger, Eningen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Car Communication GmbH

(21) Appl. No.: 11/605,195

(22) Filed: Nov. 28, 2006

(30) Foreign Application Priority Data
Nov. 30, 2005 (DE) 102005057026.7

(51) Int. Cl. B32B 3/10; B32B 27/00

(52) U.S. Cl. 428/31; 428/411.1; 428/138

(57) ABSTRACT

A motor-vehicle part made of nonconductive material is provided according to the invention with a substrate comprising a layer of nonconductive material carrying a conductive structure is fixed to the motor-vehicle part by hot-pressing such that the substrate with the conductive structure forms a surface of the part.

The invention relates to a vehicle part made of electrically nonconductive material, according to the characteristics of the preamble of claim 1.

It is basically known to make vehicle parts of electrically nonconductive material, such as plastic. Plastic vehicle parts of this type have the advantage that they offer very high design freedom, have low weight and are easy to make.

In addition, automobile manufacturers want to integrate electrically conductive structures (a substrate incompatible with UP imprinted with a compatible conductive paste (resinous basis of the paste)) on or in these plastic vehicle parts in order to make, for example, antenna structures for vehicle antennas. In addition to these conductive structures in or on the vehicle part and serving as antenna structures, it is also possible to implement electrically conductive regions for signal transmission and/or power supply. Also power can be supplied this way.

It is therefore the object of the invention to improve a vehicle part made of electrically nonconductive material, particularly a plastic material, such that integration and/or attachment of electrically conductive structures in the vehicle part is improved for the desired applications, particularly that the above-described disadvantages are avoided and the vehicle part as well as the electrically conductive structures can be made with the precision and shape required for the particular application.

This object is achieved with the characteristics of claim 1.

According to the invention, a substrate that is made of electrically nonconductive material and comprises an electrically conductive structure is attached to the vehicle part, the substrate being attached to the vehicle part by means of a hot-press method. The vehicle part as such is made of a plastic material, SMC (Sheet Molding Compound, also referred to as a resin impregnated glass mat or prepreg) or BMC materials being particularly essential and advantageous for the invention. The advantage is that a plastic part produced using a hot-press method is pressed together with a resin-impregnated paper or film during forming. Prior to that, the desired structure was applied to this substrate in the form of conductive silver paste, for example, using a printing method.

By way of example, the incorporation of paper imprinted with silver and impregnated with melamine resin in the SMC (sheet molding compound) molding method will be mentioned here. As a result of the compression force and the temperature in the tool, the materials are pressed together. Furthermore, this method results in a favorable volume reduction of the traces and hence to higher conductance values. Following demolding, the traces are located on the surface or under a thin resin layer, depending on how the substrate is oriented. It is also possible to place the substrate in advance between the cut UP (unsaturated polyester resin) resin mats. Here as well the traces would be internal. The material, however, does not have to be available in the form of cut-to-size pieces (resin mats/prepregs). It is also possible to press it together with a mixture, as is the case with BMC (bulk molding compound).

In a further embodiment of the invention, the substrate is a plastic film and therefore flexible to work with and can be adapted to the outside contours and the dimensions of the vehicle part. In addition, working with such a plastic film during the production method, meaning when pressing it together with the vehicle part, is easier than with a rigid substrate. Furthermore, however, rigid substrates such as printed circuit boards may also be used, employed particularly when the vehicle part as such is made planar at least in part.

Further advantageous embodiments of the invention will be apparent from the dependent claims, with method-related and device-related embodiments and advantages being described hereinafter.

SMC is a molding compound on the basis of glass fiber-reinforced UP resins. It is a thermosetting material. According to DIN 16913, five different SMC types have been standardized. In addition, a large number of nonstandardized SMC compositions are available, tailored to the respective application.

Application examples for SMC include the following (this list is not exhaustive): passenger car and truck production: engine hoods, trunk covers, cylinder head covers, noise encapsulation in the engine compartment and exhaust regions, tractor roofs, spoilers, parts for interior and exterior molding and the like.

BMC is available as a shapeless, doughy mass. It is processed like SMC using hot-press technology. BMC is at times also used in the injection molding technology. SMC is likewise produced from all conventional thermoset matrix systems.

Application examples for BMC include the following (this list is not exhaustive): reflectors, cylinder head covers, service switch cabinets, line safety (LS) switches, end plates, fuse strips, insulators, appliances and the like.

The advantages of SMC and BMC are that they have similar coefficients of expansion to steel, a high attenuation factor, recyclability, particularly their density results in weight advantages compared to steel, lower tooling costs, Class A surface possible, temperature stability, fire resistance, corrosion resistance, design freedom, high machine output and short processing times. In addition, they can be painted. It is therefore possible to paint over the embedded coated and/or press-molded conductive structure, which offers an additional protective function and also design advantages.

The structures are advantageously produced using a screen-printing method by printing conductive pastes. Furthermore, the substrate may or should comprise indentations and/or cutouts and/or markings. This simplifies the introduction, positioning and stabilizing of the substrate in the tool and/or optimizes the surface available for the substrate.

Alternatively, the substrate may be removed. To do so, the film (a substrate incompatible with the UP comprising a compatible conductive paste (resinous basis of the paste)) is imprinted, placed in the tool and the electrically conductive structure is aligned with the SMC/BMC. Depending on the method, the film can be removed, with the structures then having been transferred into/onto the SMC/BMC. In this case, coordination of the materials used is required.

So as to allow possible outgassing, the substrate may comprise partial cutouts. These may be filled with SMC/BMC (“squeezed”) during in-mold coating. In this case, the SMC will be located on the surface of the resultant vehicle part and allows outgassing. Mechanical joining is also possible this way.

1. A motor-vehicle part made of nonconductive material, characterized in that a substrate comprising a layer of nonconductive material carrying a conductive structure is fixed to the motor-vehicle part by hot-pressing such that the substrate with the conductive structure forms a surface of the part.

2. The motor-vehicle part according to claim 1, characterized in that the substrate is unitarily bonded with the motor-vehicle part and the electrically conductive structure is in or on the surface of the motor-vehicle part.

3. The motor-vehicle-part according to claim 1, characterized in that the substrate is unitarily bonded with the motor vehicle part and the electrically conductive structure lies under the surface.

4. The motor-vehicle part according to claim 1, characterized in that the substrate is formed with partial cutouts that facilitate outgassing of the motor-vehicle part.

5. The motor-vehicle part according to claim 1, characterized in that the substrate is a plastic foil impregnated with a resin.

6. The motor-vehicle part according to claim 1, characterized in that the substrate is separated during the pressing by a further means from the surface of the workpiece.

7. The motor-vehicle part according to claim 1, characterized in that the substrate is separated during the pressing by a further means from the surface of the workpiece and this further means is impervious to a parting compound.

8. The motor-vehicle part according to claim 1, the hot-pressing process is SMC and/or BMC.
